(19) United States
(12) Patent Application Publication
(10) Pub. No.: US 2025/0332838 A1
(43) Pub. Date: Oct. 30, 2025

(54) LIQUID STORAGE CONTAINER AND LIQUID STORAGE UNIT

(71) Applicant: CANON KABUSHIKI KAISHA, Tokyo (JP)

(72) Inventors: MITSURU CHIDA, Kanagawa (JP); JUNICHIRO IRI, Kanagawa (JP)

(21) Appl. No.: 19/083,644

(22) Filed: Mar. 19, 2025

(30) Foreign Application Priority Data
Apr. 24, 2024 (JP) 2024-070908

(51) Int. Cl. B41J 2/175

(52) U.S. Cl. CPC B41J 2/17513; B41J 2/17523; B41J 2002/17516

(57) ABSTRACT

A liquid storage container for storing a liquid to be supplied to a liquid discharge apparatus includes a cylindrical flow path-forming member in which a flow path is formed, the liquid storage container including: a liquid storage portion which stores a liquid inside and in which is formed an opening through which the liquid to be supplied to the liquid discharge apparatus passes; and an elastic portion which blocks the opening so that a liquid does not leak, the elastic portion including a communication hole configured to allow communication between inside and outside of the liquid storage portion and being configured to be elastically deformable so as to enlarge a cross-sectional area of the communication hole. The communication hole is closed in a state before the flow path-forming member is inserted into the elastic portion.

### BACKGROUND OF THE INVENTION

### Field of the Invention

The present invention relates to a liquid storage container and a liquid storage unit.

### Description of the Related Art

Liquid discharge apparatuses such as ink-jet printers are provided with a liquid discharge head mounted to a carriage that reciprocates across a recording medium. Methods of supplying a liquid such as ink to the liquid discharge head include a method of directly mounting an ink cartridge to the carriage and feeding the liquid into the ink cartridge and a method of separately providing an ink tank or a sub-tank and feeding the liquid into the head using a pump or the like.

In recent years, in order to reduce recording costs and accommodate high-volume printing, configurations in which a large-capacity ink tank is provided in an apparatus main body of a recording apparatus and a liquid storage container storing ink is connected to the apparatus main body to refill ink from the liquid storage container to the ink tank are becoming the mainstream. Japanese Patent Application Laid-open No. 2018-065374 discloses a liquid container constituted of a bag-shaped member that stores ink inside and a connecting member (hereinafter, also referred to as a spout portion) that is connected to an apparatus main body.

### SUMMARY OF THE INVENTION

In the configuration described above, in order to prevent ink leaks and other problems from occurring, the spout portion must be securely connected to the apparatus main body and a structure of the spout portion tends to become complicated. In addition, since the need to change a shape of the spout portion for each type of liquid discharge apparatus or the like from the viewpoint of preventing incorrect insertion by users makes it difficult to standardize spout portions, spout portions tend to become more expensive. Furthermore, the fact that materials containing plastic as a main raw material (hereinafter, plastic materials) are generally used for spout portions is undesirable from the perspective of achieving a sustainable society such as a decarbonized/recycling-oriented society.

In view of the problems described above, an object of the present invention is to provide a liquid container which has a simplified configuration and which enables use of plastic materials to be reduced.

In order to achieve the object described above, a liquid storage container for storing a liquid to be supplied to a liquid discharge apparatus including a cylindrical flow path-forming member in which a flow path is formed, the liquid storage container according to the present invention includes:
a liquid storage portion which stores a liquid inside and in which is formed an opening through which the liquid to be supplied to the liquid discharge apparatus passes; and
an elastic portion which blocks the opening so that a liquid does not leak, the elastic portion including a communication hole configured to allow communication between inside and outside of the liquid storage portion and being configured to be elastically deformable so as to enlarge a cross-sectional area of the communication hole,
wherein the communication hole is closed in a state before the flow path-forming member is inserted into the elastic portion.

According to the present invention, a liquid container which has a simplified configuration and which enables use of plastic materials to be reduced can be provided.

Further features of the present invention will become apparent from the following description of exemplary embodiments with reference to the attached drawings.

### BRIEF DESCRIPTION OF THE DRAWINGS

FIGS. 1A to 1C are schematic views of an ink storage container according to a first embodiment;

FIGS. 2A to 2C are explanatory diagrams of an ink supply portion according to the first embodiment;

FIGS. 3A and 3B are explanatory diagrams of an elastic member according to the first embodiment;

FIGS. 4A to 4G are explanatory diagrams of a manufacturing method of the ink storage container according to the first embodiment;

FIGS. 5A and 5B are explanatory diagrams of an ink storage container according to a first modification;

FIGS. 6A to 6C are explanatory diagrams of an ink storage unit according to a second modification;

FIGS. 7A to 7D are explanatory diagrams of an ink storage unit according to a third modification; and

FIGS. 8A and 8B are explanatory diagrams of an ink storage container according to a fourth modification.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments. In addition, not all features described in the following embodiments are essential to solutions provided by the invention.

Hereinafter, an embodiment will be described in which the present invention is applied to a liquid storage container for supplying a liquid such as ink to an inkjet recording head (liquid discharge head) and an inkjet recording apparatus (liquid discharge apparatus) that discharge ink. However, it is to be understood that the present invention is not limited to these examples. For example, the liquid storage container according to the present invention can be applied to liquid storage containers that store liquids to be supplied to apparatuses such as printers, copiers, facsimiles with communication systems, word processors with printer portions, and industrial recording apparatuses combined with various processing apparatuses.

### First Embodiment

### Ink Storage Container

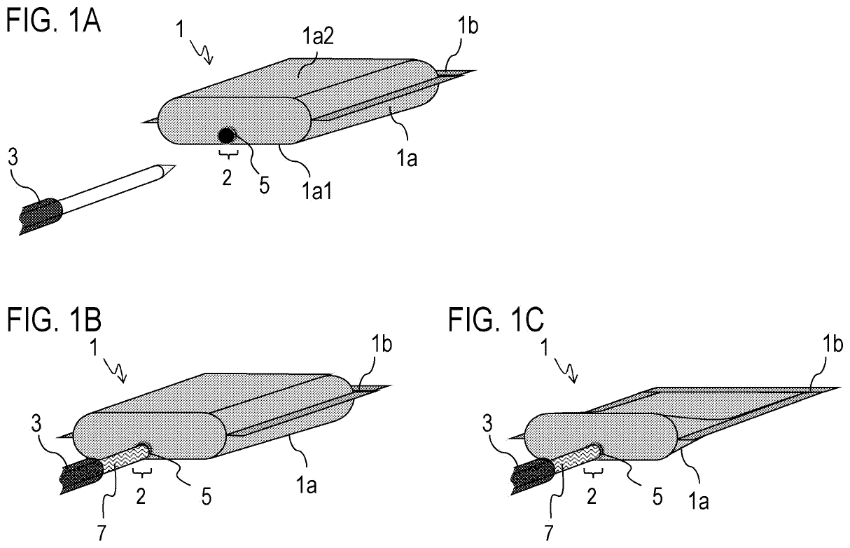

A first embodiment according to the present invention will be described. FIGS. 1A to 1C are schematic views of an ink storage container 1 according to the first embodiment. The ink storage container 1 is a liquid storage container that stores a liquid such as ink to be supplied to a liquid discharge apparatus. The ink inside the ink storage container 1 is supplied to the liquid discharge apparatus when an ink injection portion 3 provided in the liquid discharge apparatus is connected to the ink storage container 1. The ink storage container 1 can be regarded as part of the components of the liquid discharge apparatus which is removably provided in the liquid discharge apparatus. FIG. 1A is a perspective view showing external appearances of the ink storage container 1 and the ink injection portion 3.

The ink storage container 1 includes a main body portion 1a (liquid storage portion) that stores ink inside and a welded portion 1b for sealing the main body portion 1a. In the first embodiment, the main body portion 1a is formed by folding and welding a single film-like sheet member. When the ink storage container 1 is not in use, the inside of the main body portion 1a is filled with ink to be supplied to the apparatus main body of the liquid discharge apparatus. The ink storage container 1 is a flattened container of which thickness increases as its inside is filled with ink and has an approximately rectangular shape when viewed in a thickness direction. One end portion in the thickness direction of an outer circumferential surface of the main body portion 1a is a flat surface 1a1 and another end portion is a flat surface 1a2 facing the opposite direction to the flat surface 1a1.

The ink storage container 1 includes an ink supply portion 2 for supplying ink inside the ink storage container 1 to the liquid discharge apparatus. The ink supply portion 2 is provided at one end in a longitudinal direction of the rectangular shape of the main body portion 1a. In addition, the welded portion 1b is positioned at another end in the longitudinal direction of the rectangular shape of the main body portion 1a on an opposite side to where the ink supply portion 2 is provided and at both ends in a transverse direction perpendicular to the longitudinal direction. The longitudinal direction and the transverse direction are directions parallel to the flat surface 1a1.

A flexible elastic member 5 is attached to the ink supply portion 2. In addition, the liquid discharge apparatus is provided with the ink injection portion 3 with a tip pointed like a syringe needle and a hollow interior. The ink injection portion 3 is a cylindrical flow path-forming member with a flow path formed inside, which is inserted into the elastic member 5 of the ink supply portion 2 during an ink supply operation. When the ink injection portion 3 is inserted into the ink supply portion 2, the liquid discharge apparatus and the ink storage container 1 are connected and ink from the ink storage container 1 is supplied to an ink tank or a sub-tank of the liquid discharge apparatus via the flow path formed in the ink injection portion 3. FIG. 1B shows a situation where the ink injection portion 3 is inserted into the ink supply portion 2 and ink is beginning to be supplied from the ink storage container 1 to the liquid discharge apparatus. In the drawings, areas filled with ink 7 are shown filled with wavy lines.

When the amount of ink in the ink storage container 1 decreases, the ink storage container 1 collapses in the thickness direction so that the flat surface 1a1 and the flat surface 1a2 approach each other. FIG. 1C shows a situation where most of the ink in the ink storage container 1 has been supplied to the liquid discharge apparatus and the ink storage container 1 has collapsed to become smaller in the thickness direction. The ink supplied via the ink injection portion 3 is stored in the ink tank or the sub-tank of the liquid discharge apparatus and supplied to the liquid discharge head as necessary.

### Ink Supply Portion

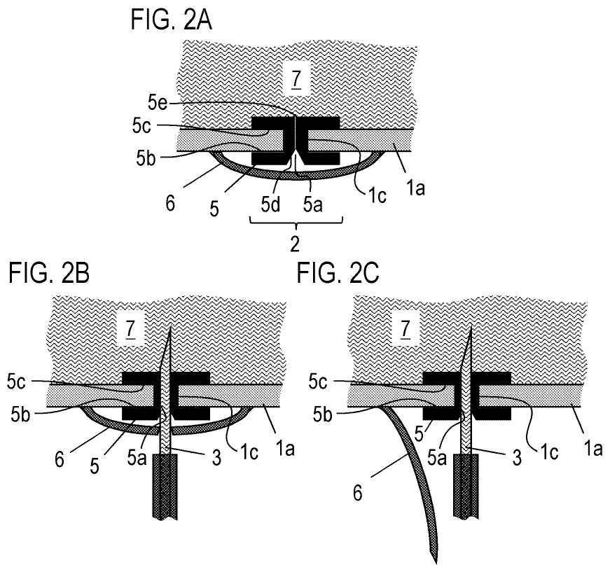

The ink supply portion 2 of the ink storage container 1 and an ink supply method (liquid supply method) from the ink storage container 1 to the liquid discharge apparatus will be described in greater detail. FIGS. 2A to 2C are explanatory diagrams of the ink supply portion 2 according to the first embodiment. FIG. 2A is a schematic sectional view showing the ink storage container 1 in an unused state (new state). An opening 1c through which ink to be supplied to the liquid discharge apparatus passes is formed in the main body portion 1a. The opening 1c has a circular sectional shape. The elastic member 5 is provided in the opening 1c.

The elastic member 5 is a member with flexibility which constitutes the elastic portion that blocks the opening 1c so that ink does not leak from the main body portion 1a. A communication hole 5a configured to allow communication between the inside and outside of the main body portion 1a is formed in the elastic member 5. The elastic member 5 is attached to the opening 1c so as to be elastically deformable so that a cross-sectional area of the communication hole 5a expands. However, the communication hole 5a may be configured to close in a state where the elastic member 5 is attached to the main body portion 1a and before the ink injection portion 3 is inserted.

The elastic member 5 has a first surface 5b that comes into contact with an outer surface of the main body portion 1a and a second surface 5c that comes into contact with an inner surface of the main body portion 1a. The first surface 5b and the second surface 5c are, respectively, in close contact with the main body portion 1a so as to cover a periphery of the opening 1c and prevent ink from leaking from between the main body portion 1a and the elastic member 5.

The communication hole 5a of the elastic member 5 includes a tapered portion 5d of which a cross-sectional area gradually increases from the inside toward the outside of the main body portion 1a and a straight portion 5e which connects to the tapered portion 5d and of which a diameter is constant. The tapered portion 5d is provided at an end portion on a side that opens to the outside of the ink storage container 1 and the straight portion 5e is provided at an end portion on a side that opens to the inside of the ink storage container 1. Sectional shapes of the tapered portion 5d and the straight portion 5e are both circular. The communication hole 5a is preferably formed with a diameter fine enough to prevent leakage of viscous ink and a diameter of the straight portion 5e is suitably about 10 μm or less. Due to the formation of the tapered portion 5d in the communication hole 5a, the ink injection portion 3 is guided by the small-diameter straight portion 5e when inserting the ink injection portion 3 into the elastic member 5 and improves workability of an ink supply operation.

The ink storage container 1 is provided with a sealing member 6 pasted to an outer surface of the main body portion 1a so as to cover the opening 1c and the elastic member 5. The sealing member 6 is provided in order to prevent ink from inadvertently leaking outside from the main body portion 1a when the communication hole 5a expands due to impact or the like and is made of a material with ink resistance.

When connecting the ink injection portion 3 to the ink storage container 1, first, the sealing member 6 is pierced by the ink injection portion 3 and the ink injection portion 3 is further inserted into the communication hole 5a of the elastic member 5 at the back. Inserting the ink injection portion 3 causes the elastic member 5 to elastically deform so as to expand the cross-sectional area (diameter) of the communication hole 5a. FIG. 2B shows a situation where the ink injection portion 3 is inserted into the communication hole 5a after piercing the sealing member 6. In a state where the tip of the ink injection portion 3 has cleared the communication hole 5a, the ink stored in the main body portion 1a is supplied to the liquid discharge apparatus through the flow path formed inside the ink injection portion 3.

When connecting the ink injection portion 3 to the ink storage container 1, a user may insert the ink injection portion 3 into the communication hole 5a after peeling off the sealing member 6 in advance. FIG. 2C shows a situation where the ink injection portion 3 is inserted into the communication hole 5a after the sealing member 6 is peeled off.

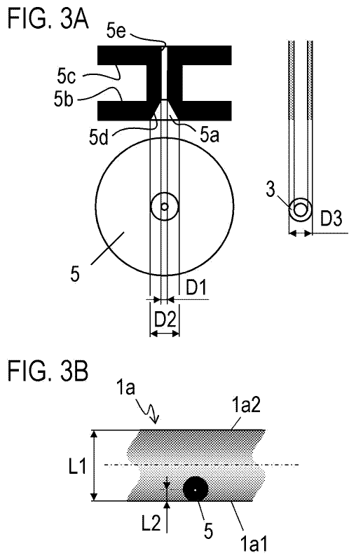

FIGS. 3A and 3B are explanatory diagrams of the elastic member 5. FIG. 3A is a schematic view showing a relationship between a diameter of the communication hole 5a of the elastic member 5 and an outer diameter of the ink injection portion 3. FIG. 3A shows a diameter of the straight portion 5e of the communication hole 5a (a minimum diameter of the tapered portion 5d) as D1, a maximum diameter of the tapered portion 5d as D2, and an outer diameter of a portion of the ink injection portion 3 to be inserted into the elastic member 5 as D3.

In the first embodiment, the elastic member 5 and the ink injection portion 3 are formed so as to satisfy D2>D3>D1. Although the larger the outer diameter D3, the greater the flow rate of ink that flows through the ink injection portion 3, when the diameter D1 is too large, ink may leak from the main body portion 1a. In consideration thereof, suitably, the diameter D1 in a state where the ink injection portion 3 is not inserted is equal to or less than ⅓ of the outer diameter D3 in consideration of the flow rate of ink or the flexibility of the elastic member 5. In addition, the diameter D2 is set larger than the outer diameter D3 because the ink injection portion 3 can be more readily guided to the straight portion 5e.

FIG. 3B is a schematic view showing an arrangement position of the elastic member 5. FIG. 3B shows the thickness of the main body portion 1a of the ink storage container 1 (distance from flat surface 1a1 to flat surface 1a2) when the ink storage container 1 is unused as L1 and the distance from the flat surface 1a1 to a circular center of the communication hole 5a of the elastic member 5 as L2. The ink storage container 1 is configured to supply ink from the main body portion 1a to the ink supply portion in a state where the flat surface 1a1 is placed on a horizontal surface. In consideration thereof, the elastic member 5 is arranged closer to the flat surface 1a1 than the flat surface 1a2 in the thickness direction in order to enable ink that accumulates on the side of the flat surface 1a1 to be the bottom of the main body portion 1a without leaving excess ink. In other words, setting the distance L2 equal to or less than ½ of the distance L1 is suitable from the perspective of eliminating ink waste.

### Manufacturing Method of Ink Storage Container

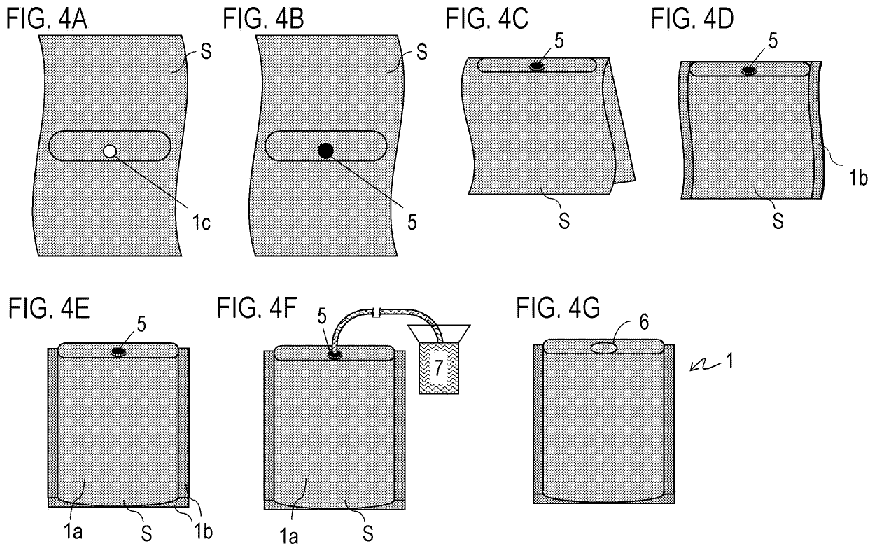

A specific example of a manufacturing method of the ink storage container 1 will be described. FIGS. 4A to 4G are explanatory diagrams of the manufacturing method of the ink storage container 1.

The ink storage container 1 is made of a sheet S being a multilayer film in which thin sheets of Al, nylon, polyethylene, or the like are laminated. The sheet S has an approximately rectangular shape and has the opening 1c for connection to the liquid discharge apparatus at approximate centers in the longitudinal direction and the transverse direction. FIG. 4A shows the sheet S in which the opening 1c is formed.

The elastic member 5 is attached to the sheet S so as to be fitted into the opening 1c. For example, the elastic member 5 is made of a member which contains at least one of fluoro rubber, nitrile rubber, butyl rubber, and chloroprene rubber and which has flexibility. FIG. 4B shows a situation where the elastic member 5 is fitted into the opening 1c and attached to the sheet S.

The sheet S with the elastic member 5 attached thereto is folded roughly in half. At this point, a portion provided with the elastic member 5 to be the ink supply portion 2 is positioned at the folded portion. However, since folding the elastic member 5 makes it difficult to insert the ink injection portion 3, a vicinity of the opening 1c provided with the elastic member 5 is suitably constructed with certain strength to prevent bending. FIG. 4C shows a situation where the sheet S is folded roughly in half.

The folded sheet S is first heated and welded at both end portions in the transverse direction. FIG. 4D shows a situation where the welded portion 1b is formed at both end portions in the transverse direction of the sheet S. Subsequently, the sheet S is heated and welded at an end portion on an opposite side to the side where the elastic member 5 is provided in the longitudinal direction. FIG. 4E shows a situation where the welded portion 1b is formed at one end portion (rear end portion) in the longitudinal direction of the sheet S. The main body portion 1a of the ink storage container 1 is formed in this manner.

Ink 7 is injected via the elastic member 5 into the ink storage container 1 having been sealed and made into a bag by welding. FIG. 4F shows a situation where the ink 7 is injected into the main body portion 1a.

After the injection of ink, the sealing member 6 made of a material with ink resistance is pasted so as to cover an entire area of the elastic member 5 to complete the ink storage container 1. FIG. 4G shows a situation where the sealing member 6 has been pasted and the ink storage container 1 is completed.

As described above, according to the present invention, a configuration of a connecting portion to the liquid discharge apparatus can be simplified. Therefore, for example, even if the shape of the elastic member 5 is changed for each type of liquid discharge apparatus for the purpose of preventing incorrect insertion, the liquid discharge apparatus will be less expensive compared to a configuration with a complicated connecting portion. In addition, according to the present invention, the number of components such as a spout portion that need to be formed with resins such as plastic can be reduced and a particular contribution can be made to Reduce among the “Three Rs”. The technologies described in this specification have the potential to contribute to the achievement of a sustainable society, such as a decarbonized society/circular society.

Note that the configuration and the manufacturing method of the ink storage container 1 are not limited to those described above. For example, the ink storage container 1 may be formed by connecting a supplying member in which the opening 1c is formed and two films to each other by welding or the like. In addition, for example, in a configuration in which the sealing member 6 is pasted on the inside of the main body portion 1a, the communication hole 5a may be solely constituted of the tapered portion 5d instead of providing the communication hole 5a with the straight portion 5e. Hereinafter, modifications will be described in which a part of the configuration of the first embodiment has been changed.

### First Modification

A first modification of the first embodiment will be described. In the following description, components similar to those of the first embodiment among the components of the first modification will be denoted by same reference signs and descriptions thereof will be omitted and characteristic portions of the first modification will be mainly described. The first modification differs from the first embodiment in the position where the sealing member 6 is pasted.

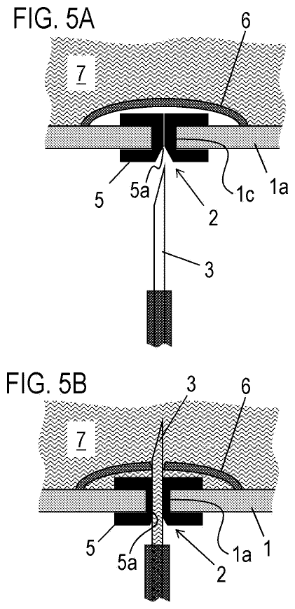

FIGS. 5A and 5B are explanatory diagrams of the ink storage container 1 according to the first modification. In the first modification, the sealing member 6 is pasted to the inside of the ink storage container 1. FIG. 5A is a schematic sectional view showing the ink storage container 1 in an unused state (new state). In the first modification, the sealing member 6 is pasted to an inner surface of the main body portion 1a so as to cover the opening 1c and the elastic member 5. Therefore, ink does not penetrate into an area in which the elastic member 5 is arranged and which is covered by the sealing member 6 inside the main body portion 1a.

When connecting the ink injection portion 3 to the ink storage container 1, first, the ink injection portion 3 is inserted into the elastic member 5 and, subsequently, the ink injection portion 3 is further inserted toward the back until the sealing member 6 is pierced by the tip of the ink injection portion 3. Once the sealing member 6 is pierced, the ink stored in the main body portion 1a is supplied to the liquid discharge apparatus through the flow path formed inside the ink injection portion 3. FIG. 5B shows a situation where the ink injection portion 3 is inserted into the communication hole 5a and the sealing member 6 is pierced.

An example of the manufacturing method of the ink storage container 1 will be described. When manufacturing the ink storage container 1, after the elastic member 5 is pasted to the sheet S, the sealing member 6 is pasted to the sheet S before welding the sheet S. At this point, the sealing member 6 is pasted to a surface to become an inner surface of the main body portion 1a so as to cover the opening 1c and the elastic member 5.

The sheet S is folded and both end portions in the transverse direction are heated and welded in a state where the elastic member 5 and the sealing member 6 are provided. In addition, ink is injected into the main body portion 1a from the end portion in the longitudinal direction (the rear end portion of the ink storage container 1) that is not yet welded. After a prescribed amount of the ink 7 is injected, the rear end portion of the ink storage container 1 is welded to complete the ink storage container 1.

### Second Modification

A second modification of the first embodiment will be described. In the following description, components similar to those of the first embodiment among the components of the second modification will be denoted by same reference signs and descriptions thereof will be omitted and characteristic portions of the second modification will be mainly described. The second modification differs from the first embodiment in that the ink storage container 1 is connected to the liquid discharge apparatus in a state where the ink storage container 1 is stored in a storage case 8.

In the first embodiment, the ink injection portion 3 is directly inserted into the elastic member 5 of the ink storage container 1. On the other hand, in the second modification, the ink injection portion 3 is connected to an ink storage unit 9 (liquid storage unit) constituted of the ink storage container 1 and the storage case 8 which stores the ink storage container 1.

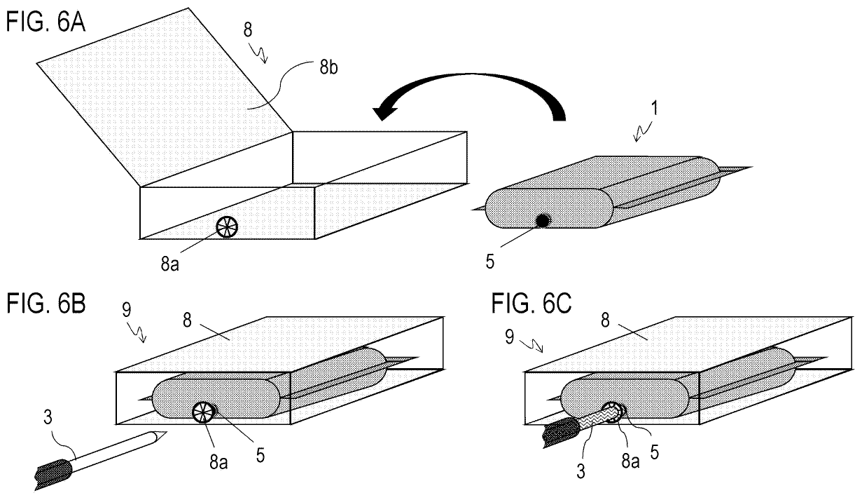

FIGS. 6A to 6C are explanatory diagrams of the ink storage unit 9 according to the second modification. The storage case 8 is provided with an insertion port 8a into which the ink injection portion 3 is inserted and a cover 8b for opening and closing a space in which the ink storage container 1 is stored. For example, the insertion port 8a can be constituted of a sheet-like member that is flexible enough to open when the ink injection portion 3 is inserted. FIG. 6A is a perspective view showing external appearances of the ink storage container 1 and the storage case 8 according to the second modification.

In a state where the ink storage container 1 is stored in the storage case 8, the insertion port 8a and the elastic member 5 are at overlapping positions when viewed in an insertion direction of the ink injection portion 3 (the longitudinal direction of the ink storage container 1). Therefore, the ink injection portion 3 is inserted into the elastic member 5 by inserting the ink injection portion 3 into the insertion port 8a and, further, pushing the ink injection portion 3 to the back. FIG. 6B is a perspective view showing a state before the ink injection portion 3 is inserted into the ink storage unit 9. FIG. 6C is a perspective view showing a state after the ink injection portion 3 is inserted into the ink storage unit 9. Note that a positioning portion for positioning the insertion port 8a and the elastic member 5 may be provided in the ink storage container 1 or the storage case 8.

According to the second modification, the ink storage container 1 can be connected to the ink injection portion 3 of the liquid discharge apparatus in a state where the ink storage container 1 is stored in the storage case 8. The present configuration is particularly suitable when it is difficult to independently fix and place the ink storage container 1.

### Third Modification

A third modification of the first embodiment will be described. In the following description, components similar to those of the first embodiment among the components of the third modification will be denoted by same reference signs and descriptions thereof will be omitted and characteristic portions of the third modification will be mainly described. In the third modification, the ink storage container 1 is connected to the liquid discharge apparatus in a state where the ink storage container 1 is stored in the storage case 8 in a similar manner to the second modification.

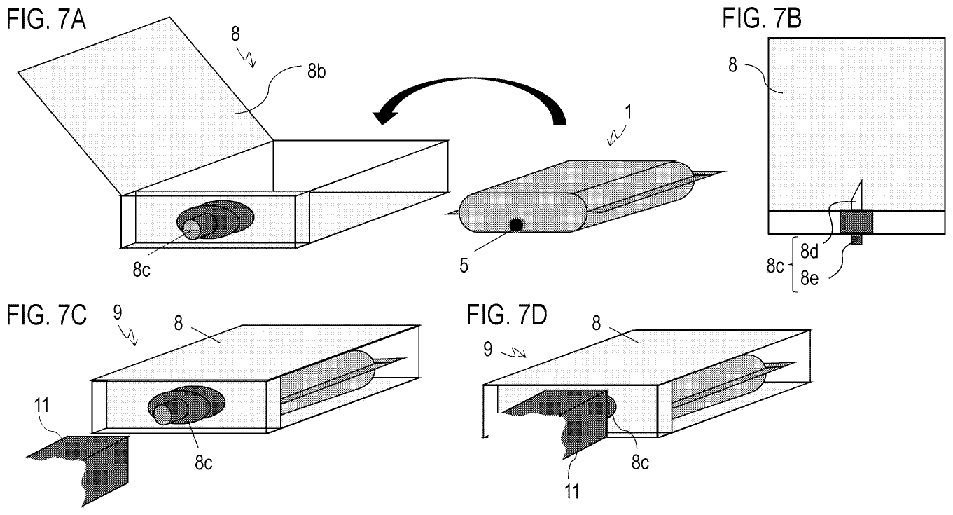

FIGS. 7A to 7D are explanatory diagrams of the ink storage unit 9 according to the third modification. Even in the third modification, an ink injection portion 11 provided in the liquid discharge apparatus is connected to the ink storage unit 9 (liquid storage unit) constituted of the ink storage container 1 and the storage case 8. In the storage case 8 according to the third modification, a connecting portion 8c for connecting the ink injection portion 11 of the liquid discharge apparatus and the ink storage container 1 to each other to supply ink from the ink storage container 1 to the liquid discharge apparatus is formed. FIG. 7A is a perspective view showing external appearances of the ink storage container 1 and the storage case 8 according to the third modification.

FIG. 7B is a plan view showing a configuration of the storage case 8. The connecting portion 8c includes a first connecting portion 8d which is inserted into the elastic member 5 of the ink storage container 1 and which is connected to the ink storage container 1 and a second connecting portion 8e which is connected to the ink injection portion 11 of the liquid discharge apparatus, and a flow path for ink to flow is formed inside the connecting portion 8c.

The first connecting portion 8d is configured in a similar manner to the ink injection portion 3 provided in the liquid discharge apparatus according to the first embodiment and functions as a flow path-forming member with a tip pointed like a syringe needle and a hollow interior. Configurations of the second connecting portion 8e and the ink injection portion 11 are not particularly limited and ink having flowed to the first connecting portion 8d need only be suppliable to an ink tank of the apparatus main body or the like via the second connecting portion 8e and the ink injection portion 11. FIG. 7C is a perspective view showing a state before the ink injection portion 11 is inserted into the ink storage unit 9. FIG. 7D is a perspective view showing a state after the ink injection portion 11 is inserted into the ink storage unit 9.

The ink storage container 1 is stored in the storage case 8 in a state where the first connecting portion 8d is inserted into the elastic member 5. In the state where the first connecting portion 8d is inserted into the elastic member 5, the flow path of the second connecting portion 8e is closed and ink is prevented from leaking from the second connecting portion 8e. In addition, by connecting the ink injection portion 11 to the second connecting portion 8e, the flow path of the second connecting portion 8e opens, the inside of the main body portion 1a of the ink storage container 1 and the ink injection portion 11 communicate with each other, and ink can be supplied from the ink storage container 1 to the ink injection portion 11. Even in such a configuration, the ink storage container 1 can be connected to the ink injection portion 3 of the liquid discharge apparatus in a state where the ink storage container 1 is stored in the storage case 8. Therefore, the present configuration is particularly suitable when it is difficult to independently fix and place the ink storage container 1.

### Fourth Modification

A fourth modification of the first embodiment will be described. In the following description, components similar to those of the first embodiment among the components of the fourth modification will be denoted by same reference signs and descriptions thereof will be omitted and characteristic portions of the fourth modification will be mainly described. The fourth modification differs from the first embodiment in that the ink supply portion 2 is provided on the flat surface 1a1 that is a lower surface of the ink storage container 1.

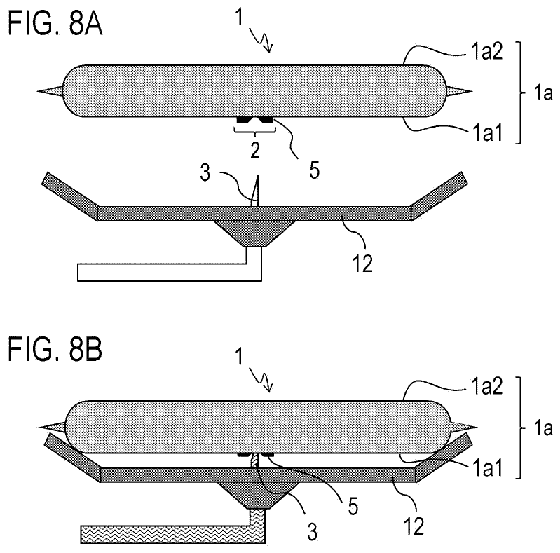

FIGS. 8A and 8B are explanatory diagrams of the ink storage container 1 according to the fourth modification. In the fourth modification, the elastic member 5 is provided and the ink supply portion 2 is formed on the flat surface 1a1 to be a lower surface in a posture of the ink storage container 1 when connected to the ink injection portion 3.

The liquid discharge apparatus according to the fourth modification includes a mounting portion 12 on which the ink storage container 1 is mounted when supplying ink. The mounting portion 12 is provided with the ink injection portion 3 including a cylindrical flow path-forming member that protrudes upward in a vertical direction. Therefore, by mounting the ink storage container 1 on the mounting portion 12 so that the ink injection portion 3 is inserted into the elastic member 5, the ink storage container 1 and the ink injection portion 3 are connected to each other and ink is supplied from the ink storage container 1 to the liquid discharge apparatus.

According to the present example, since the ink storage container 1 and the liquid discharge apparatus can be connected simply by mounting the ink storage container 1, workability of an ink supply operation improves. In addition, even if a small amount of ink leaks to the outside of the main body portion 1a when the ink injection portion 3 is inserted into the elastic member 5, since the mounting portion 12 catches the ink, peripheral members and the like can be prevented from becoming stained. Furthermore, a configuration that enables ink to be supplied with less waste may be adopted by providing a supply port or the like in the mounting portion 12 so that ink that leaks onto the mounting portion 12 can also be supplied to the liquid discharge apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-070908, filed on Apr. 24, 2024, which is hereby incorporated by reference herein in its entirety.

What is claimed is:

1. A liquid storage container for storing a liquid to be supplied to a liquid discharge apparatus including a cylindrical flow path-forming member in which a flow path is formed, the liquid storage container comprising:
a liquid storage portion which stores a liquid inside and in which is formed an opening through which the liquid to be supplied to the liquid discharge apparatus passes; and
an elastic portion which blocks the opening so that a liquid does not leak, the elastic portion including a communication hole configured to allow communication between inside and outside of the liquid storage portion and being configured to be elastically deformable so as to enlarge a cross-sectional area of the communication hole,
wherein the communication hole is closed in a state before the flow path-forming member is inserted into the elastic portion.

2. The liquid storage container according to claim 1,
wherein the communication hole communicates the inside and the outside of the liquid storage portion in a state before the flow path-forming member is inserted into the elastic portion.

3. The liquid storage container according to claim 1, further comprising:
a sealing portion arranged outside of the liquid storage portion so as to cover the opening.

4. The liquid storage container according to claim 1, further comprising:
a sealing portion arranged inside the liquid storage portion so as to cover the opening.

5. The liquid storage container according to claim 1,
wherein cross-sectional shapes of the communication hole and the opening are circular, and
wherein a diameter of the communication hole in a state where the flow path-forming member is not inserted is equal to or less than ⅓ of a diameter of the opening.

6. The liquid storage container according to claim 1,
wherein a part of an outer circumferential surface of the liquid storage portion is a flat surface, and a liquid is supplied from the liquid storage portion to the flow path-forming member in a state where the flat surface is placed on a horizontal surface.

7. The liquid storage container according to claim 6,
wherein cross-sectional shapes of the communication hole and the opening are circular, and
wherein in a state where the flat surface is placed on the horizontal surface, a distance from the flat surface to a circular center of the cross-sectional shape of the opening is equal to or less than ½ of a distance from the flat surface to a surface facing an opposite side to the flat surface of the outer circumferential surface.

8. The liquid storage container according to claim 1,
wherein the elastic portion contains at least one of fluoro rubber, nitrile rubber, butyl rubber, and chloroprene rubber.

9. The liquid storage container according to claim 1,
wherein the liquid storage portion is formed by a film with flexibility.

10. The liquid storage container according to claim 1,
wherein the communication hole includes a tapered portion at an end portion on a side that opens to the outside of the liquid storage portion, a cross-sectional area of the tapered portion gradually increasing from the inside toward the outside of the liquid storage portion.

11. A liquid storage container for storing a liquid, the liquid storage container comprising:
a liquid storage portion which stores a liquid inside and in which is formed an opening through which the liquid passes; and
an elastic portion which blocks the opening so that a liquid does not leak, the elastic portion including a communication hole configured to allow communication between inside and outside of the liquid storage portion and being configured to be elastically deformable so as to enlarge a cross-sectional area of the communication hole,
wherein the communication hole is closed in a state before the flow path-forming member is inserted into the elastic portion.

12. A liquid storage unit for storing a liquid to be supplied to a liquid discharge apparatus, the liquid storage unit comprising:
a liquid storage container including a liquid storage portion which stores a liquid inside and in which is formed an opening through which the liquid to be supplied to the liquid discharge apparatus passes and an elastic portion which blocks the opening so that a liquid does not leak, the elastic portion including a communication hole configured to allow communication between inside and outside of the liquid storage portion; and
a storage case which includes a cylindrical flow path-forming member in which a flow path is formed and a connecting portion to be connected to the liquid discharge apparatus and which stores the liquid storage container inside,
wherein the flow path-forming member is inserted into the elastic portion and the elastic portion is elastically deformed so as to enlarge a cross-sectional area of the communication hole, and
wherein the communication hole is closed in a state before the flow path-forming member is inserted into the elastic portion.
